(19) United States
(12) Patent Application Publication
(10) Pub. No.: US 2026/0364607 A1
(43) Pub. Date: Nov. 19, 2026

(54) METHOD AND APPARATUS FOR DETERMINING A WEAR PROFILE OF A WEAR LINER

(71) Applicant: FLSmidth A/S, Valby (DK)

(72) Inventors: JAYACHANDRAN MANOHARAN, RIVERTON, UT (US); MICHAEL HALES, SALT LAKE CITY, UT (US); CRISTIAN FLORES, SANTIAGO (CL); JOSE RAUL FERNANDEZ, SANTIAGO (CL); POUL FOGH, ALBERTSLUND (DK); JONATHAN MELTON, OGDEN, UT (US)

(21) Appl. No.: 19/139,480

(22) PCT Filed: Dec. 15, 2023
(86) PCT No.: PCT/IB2023/062780

§ 371 Date: Jun. 16, 2025

Related U.S. Application Data
(60) Provisional application No. 63/432,987, filed on Dec. 15, 2022.

(51) Int. Cl. B02C 17/22

(52) U.S. Cl. CPC B02C 17/22; B02C 2210/01

(57) ABSTRACT

A wear liner assembly (3) may be composed of a wear liner (4) and a 2D wear sensor (5). The wear liner (4) may be provided with a first distal end (10), a second distal end (11) opposite the first distal end (10), and a first recess (9) in at least the first distal end (10). The 2D wear sensor (5) may be disposed within the first recess (9). The 2D wear sensor (5) may comprise a core or body (6) (e.g., a printed circuit board (PCB)) containing a plurality of 1D wear sensors (7). Each of the 1D wear sensors (7) may be spaced from one another, and may, in some embodiments, be oriented to extend in substantially the same direction and/or within substantially the same plane.

### FIELD OF THE INVENTION

The invention relates to improvements to wear liners suitable for industrial use on equipment within the mining, cement, aggregate, and minerals processing arts. Such equipment may include, for example (and without limitation), ball mills, semi-autogenous grinding (SAG) mills, rod mills, scrubber mills, and/or other types of grinding mills- and the wear liners may collectively form a portion of a wear lining system (e.g., a mill lining system). Certain embodiments of the invention may relate to apparatus and methods which enable the detection of erosive wear of mill liners (e.g., lifters).

### BACKGROUND TO THE INVENTION

Reference to background art herein is not to be construed as an admission that such art constitutes common general knowledge in the arts.

Wear liners (e.g., “lifters” or “wear panels”) are typically used in the cement, mining, aggregate, minerals processing, and materials handling industries (e.g., within horizontal rotating mills) in order to increase the life of equipment, decrease maintenance downtime and increase throughput. Such wear liners are typically secured to the floor, inner surfaces, and/or walls of chutes, hoppers, bins, tanks, separator devices, fan housings and other equipment where abrasive or corrosive material, friction and/or impact may cause rapid wear deterioration of the same. Within the context of chutes, bins, hoppers and feeders, in order to provide an area of protective coverage or lining in sliding contact with materials such as crushed rock, coal, ore, grain and other abrasive aggregates, wear plates may be used. Within the context of rotating equipment, mills and crushers may similarly be provided with an area of protective coverage or lining in sliding contact with materials such as crushed rock, coal, ore, grain and other abrasive aggregates. For example, wear liners can be used in industrial primary comminution equipment such as gyratory and/or cone crushers,—and/or tumbling mills, without limitation.

There are existing methods to determine wear to a liner. For example, the provision of embedded colored inserts has been proposed (for allowing manual visual indication of color change upon wear inspection). 3D laser scanning techniques have been employed to optically measure a wear liner surface profile (however, this often requires shutdown of equipment). Specially-formulated fasteners (e.g., “smart bolts”) having embedded sensors therein have also been proposed (however, the location of these fasteners is fixed and may lead to low resolution surface profile datasets).

Because grinding mills are key equipment in a mine's processing flowsheet, maximizing operating and service efficiency and optimizing planned down time are essential to maximize profitability. As mill wear liners deteriorate due to abrasive erosion, it changes dynamic environments within the mill and can reduce operating efficiency. Thus, a mill operator may need to change mill operating parameters to re-establish optimum operational performance.

While several systems for performance optimization exist (such as FLSmidth@ LoadIQ™ mill loading and smart sensor automation technology), higher resolution of information regarding the state (e.g. service condition) of wear liners can provide valuable input on how to adjust mill operation input control parameters. Better data surrounding wear liner states/conditions may also enable an operator or user of a mill to know when it is essential to exchange the worn wear liners for new replacements. While 3D imaging scans of wear liners currently provide some of this information, that data is heretofore not available online (i.e., the mill has to be stopped and cleared for each imaging scan). This is detrimental to production and leads to lower machine time availability, increased OPEX, reduced throughput, higher energy costs, and a plethora of other disadvantages.

With particular regards to mills, steel liners and other mill liners are high-risk parts. While these are intentionally designed for eventual replacement, if their integrity fails prematurely during operation, exposure of underlying “non-serviceable” equipment components (e.g., a mill shell or other substrate below a mill liner) is likely. Thus, the potential for costly damage to portions of the mill remains an unfortunate reality. Thus, modifying an otherwise robust wear liner by drilling holes through it (which can already be difficult or next to impossible in some steel materials) is seen by the industry as introducing adverse risk. A smarter manner in which to install wear sensing apparatus within a mill lining system must be investigated. Moreover, a sensor that measures liner wear better (e.g., provides data for measuring changes to both profile and height), yet does not require major rework or intrusive ingress into the liners is sought.

While the total wear of metal liners can be necessary information to help equipment operators plan for wear out and replacement of wear liner part, equally-important information for the equipment operator is the wear liner “profile”. The wear profile information not only allows equipment operators to strategically plan maintenance cycles, but further helps equipment operators determine equipment efficiency. For example, in the case of mills, the power required for efficient milling operations depends significantly on the ability of wear liners to “lift” the load inside the mill. Similar to how tire wear for automobiles degrades handling performance, performance and efficiency of comminution equipment can be optimized by virtue of better understandings of an outer-facing wear profile or surface of a wear lining system.

Accordingly, there has been a long-felt need to introduce an improved way of measuring wear of liners of industrial comminution equipment. More specifically, there is a need for a better technical solution which can deliver online, real-time, high-resolution analysis and datasets (e.g., 3D point clouds) pertaining to wear liner surface profiles without decommissioning or stopping operation of comminution equipment—in particular, grinding mills such as horizontal grinding mills (e.g., ball mills, SAG mills, rod mills, and the like, without limitation).

For purposes of referencing the prior art, WO19086577, AU2012238221, US2022/048037A1, and U.S. Pat. No. 3,565,352 provide some general examples of state-of-the-art solutions.

### OBJECTS OF THE INVENTION

Some embodiments of the present invention aim to provide an improved wear sensor apparatus configured to detect wear across a profile of a wear liner, preferably a substantial portion of a peripheral surface or edge of said wear liner.

Some embodiments of the present invention aim to provide an improved wear liner having one or more novel features which make the novel wear liner uniquely-configured for accepting, receiving, and integrating said improved wear sensor apparatus therewith.

Some embodiments of the present invention aim to provide an improved wear liner assembly comprising a combination of the improved wear liner and one or more of the improved wear sensor apparatus described and/or depicted herein, for use within a novel “smart” wear lining system.

Some embodiments of the present invention aim to provide an improved wear sensor or wear detection apparatus that is configured to be integrated with or the wear liner to form a wear liner assembly without weakening the underlying core structure of the wear liner.

Some embodiments of the present invention aim to provide on-line, real-time readings which data thereof can be used to draw conclusions about the outer-facing wear surface profile of a wear liner.

According to some embodiments, the provided system, method, and/or apparatus may be configured such that this data is capable of being transmitted to a base station, forwarded to an ECS, or uploaded to a cloud processing service for analysis and/or use.

In some particular embodiments of the present invention, it is an aim to provide the above advantages specifically for a mill liner (e.g., a lifter) for improved wear detection of the same within a rotating horizontal grinding mill.

It is an aim of all embodiments to provide a system, method, and/or apparatus which overcomes or ameliorates one or more of the disadvantages or problems described above—or, which at least provides a useful alternative.

Other preferred objects of the present invention will become apparent from the following description.

### SUMMARY OF INVENTION

According to embodiments of the invention, a wear liner assembly, wear sensor, wear liner, wear lining system, and method of determining wear to a profile of one or more wear liners is disclosed.

A wear liner assembly (3) is disclosed. The wear liner assembly (3) may be configured for use within a wear lining system (2), such as a wear lining system (2) provided within industrial comminution equipment. The industrial comminution equipment may comprise a grinding apparatus (1) such as a crusher, mill, or the like, without limitation, but may also include ancillary equipment such as chutes, hoppers, vibratory feeders, and other equipment having surfaces exposed to abrasive wear, without limitation.

The wear liner assembly (3) may comprise a wear liner (4). The wear liner (4) may comprise a first distal end (10), and a second distal end (11) opposite the first distal end.

The first distal end (10) may comprise a first recess (9) in at least the first distal end (10). A first 2D wear sensor (5) may be disposed within a least a portion of the first recess (9) of the wear liner (4). The first 2D wear sensor (5) may comprise a core or body (6). The core or body (6) may contain (e.g., thereon or therein) a single one- or a plurality of 1D wear sensors (7). Each of the 1D wear sensors (7) may be spaced from one another. Each of the 1D wear sensors may be oriented to extend in substantially the same direction and/or within substantially the same plane, without limitation.

In some embodiments, the wear liner assembly (3) may further comprise a first spacing insert, adapter, or protective component (14) within the first recess (9), without limitation.

In some embodiments, the first spacing insert, adapter, or protective component (14) may be configured to shield, case, or protect the core or body (6) of the first 2D wear sensor (5), without limitation.

In some embodiments, at least one mounting element (8) may be provided to the recess (9). A corresponding at least one mounting element (12) may be provided to the first 2D wear sensor (5). The at least one mounting element (12) provided to the first 2D wear sensor (5) may be configured to communicate with the mounting element (8) provided to the recess (9), without limitation.

In some embodiments, wherein upon communication between the mounting element (8) provided to the recess (9) and the mounting element (12) provided to the first 2D wear sensor (5), the 2D wear sensor (5) may be properly oriented within the first recess (9) with respect to the wear liner (4), without limitation.

In some embodiments, the wear liner assembly (3) may further comprise a second recess (9) in the second distal end (11). A second 2D wear sensor (5) may be disposed within a least a portion of the second recess (12) of the wear liner (4). The second 2D wear sensor (5) may comprise a core or body (6). The core or body (6) may contain (e.g., thereon or therein) a single one—or a plurality of 1D wear sensors (7). Each of the 1D wear sensors (7) may be spaced from one another. Each of the 1D wear sensors may be oriented to extend in substantially the same direction and/or within substantially the same plane, without limitation.

In some embodiments, the wear liner assembly (3) may comprise at least one third sensor (9) extending through a central portion of the wear liner, the at least one third sensor comprising: a 2D wear sensor (5) comprising a plurality of 1D wear sensors (7), or, a 1D wear sensor (7), without limitation. The at least one third sensor may be positioned within at least one third recess (9) extending substantially transversely and/or orthogonally to an axis extending from the first distal end (10) to the second distal end (11), without limitation.

In some embodiments, the at least one third sensor may be provided within a recess (9) that intersects with a pocket (25) provided in a lower undersurface of the wear liner (4), without limitation. The pocket (25) may be positioned opposite an outer-facing wear surface profile (22) of the wear liner (4), without limitation.

In some embodiments, the wear liner (4) may comprise a passage (13) extending from a pocket (25) provided in a lower undersurface of the wear liner (4), to the first recess (9), without limitation.

In some embodiments, the wear liner (4) may comprise a passage (13) extending from the pocket (25) to a second recess (9) provided to the second distal end (11), without limitation. In some embodiments, at least one, a plurality of—or each of the 1D wear sensors of the first 2D wear sensor may extend in a direction towards an outer-facing wear surface profile (22) of the wear liner (4) or first 2D wear sensor (5), without limitation.

In some embodiments, at least two—or each of the 1D wear sensors (7) of the first 2D wear sensor (5) may extend substantially same direction, without limitation.

In some embodiments, at least one, a plurality of,—or each of the 1D wear sensors (7) of the first 2D wear sensor (5) may extend substantially radially towards a central axis of a horizontal grinding mill (1), without limitation.

In some embodiments, the first 2D wear sensor (5) may be configured to broadcast a signal wirelessly via an onboard antenna (21), without limitation. The signal may be delivered to a receiver located above the outer-facing wear surface profile (22). The signal may be delivered to a module (30), such as one located below a lower undersurface of a wear liner (4) or wear lining system (2).

In some embodiments, the first 2D wear sensor (5) may be configured with a wire or cable (17) to deliver a signal. The signal may be delivered via the wire or cable to a remotely positioned module (30). The module (30) may be located within, partially within, extend into, communicate with, or be operably connected to a pocket (25) on the wear liner assembly (3), without limitation. The wire or cable (17) may comprise a connector (33) for connection to a mating connector (33) extending from the module (30). It should be understood that one or more wires or cables (17) may extend from a 1D wear sensor (7) described herein, without limitation.

In some embodiments, a spacing insert, adapter, or protective plate (14) may comprise one or more mounting features (18) that align with the one or more mounting features (12) of the first 2D wear sensor (5), without limitation.

In some embodiments, the core or body (6) of a 1D wear sensor (7) or 2D wear sensor (5) may comprise a printed circuit board (6).

In some embodiments, at least two of the 1D wear sensors (7) of the first 2D wear sensor (5) may extend in different directions and/or at an angle with respect to one another, for example, such that a first longitudinal wear measuring axis defined along a first one of the at least two of the 1D wear sensors (7) is not parallel to a second longitudinal wear measuring axis defined along a second one of the at least two of the 1D wear sensors (7), without limitation.

In some embodiments, at least one of the 1D wear sensors (7) of the first 2D wear sensor (5) may extend substantially orthogonally and/or substantially perpendicular to an outer-facing wear surface profile (22) of the wear liner (4), without limitation.

In some embodiments, a plurality of said 1D sensors (7) may be positioned at a non-perpendicular angle relative to an outer-facing wear surface profile (22) of the wear liner (4), without limitation.

A method of optimizing operating efficiency of a grinding apparatus (1), such as a mill, a crusher, or other piece of comminution equipment having a wear lining system (2) therein is also disclosed.

The method may comprise the step of providing the wear liner assembly (3) according to any one of the abovementioned embodiments to the wear lining system (2), such that an outer-facing wear surface profile (22) of the wear liner (4) portion of the wear liner assembly (3) forms a portion of an outer-facing wear surface profile (22) of the wear lining system (2), without limitation.

The method may comprise the step of monitoring a condition of the first 2D wear sensor (5) —for example, by virtue of receiving (e.g., to a receiver operably communicating with a computer) one or more signals from the first 2D wear sensor (5); the one or more signals from the first 2D wear sensor (5) comprising wear data associated with a wear condition or physical state of each one of the 1D wear sensors (7), without limitation.

The method may comprise the step of processing the wear data using a computer equipped with a processor and a non-transitory computer-readable medium, without limitation.

The method may comprise the step of creating a two-dimensional electronic digital twin or point cloud representation of the wear data, using the wear data from the one or more signals from the first 2D wear sensor (5), without limitation.

The method may comprise the step of determining an operating efficiency of the grinding apparatus 1, based on said electronic digital twin or point cloud representation of the wear data, without limitation.

In some embodiments, the method may comprise the step of providing a plurality of the aforementioned wear liner assembly (3) to the wear lining system (2), without limitation.

In some embodiments, the method may comprise the step of monitoring a condition of each first 2D wear sensor (5) of each wear liner assembly (3), for example-by virtue of receiving one or more signals from each first 2D wear sensor (5); the one or more signals from each first 2D wear sensor (5) comprising wear data associated with a wear condition or physical state of the 1D wear sensors (7) associated with each first 2D wear sensor (5), without limitation.

In some embodiments, the method may comprise the step of processing wear data from each of the first 2D wear sensor (5) using a computer (e.g., a computing device equipped with a processor and a non-transitory computer-readable medium), without limitation.

In some embodiments, the method may comprise the step of creating a three-dimensional electronic digital twin or point cloud representation of the wear data, using the wear data from the one or more signals from each first 2D wear sensor (5), without limitation.

In some embodiments, the method may comprise the step of determining an operating efficiency of the grinding apparatus 1, based on said electronic digital twin or point cloud representation of the wear data, without limitation.

In some embodiments, the method may comprise the step of determining if said operating efficiency is below a predetermined threshold or value, without limitation.

In some embodiments, the method may comprise the step of replacing or scheduling the replacement the entire wear lining system (2) or a portion thereof, such as replacing one or more of the wear liner assembly (3) if the operating efficiency is below the predetermined threshold or value, without limitation.

In some embodiments, a wear liner assembly (3) for a wear lining system (2) provided within industrial comminution equipment may comprise a wear liner (4). The wear liner (4) may comprise a first distal end (10) and a second distal end (11) opposite the first distal end. The first distal end (10) may comprise at least a first recess (9) in at least the first distal end (10). At least a first 1D wear sensor (7) may be disposed within a least a portion of the first recess (9) of the wear liner (4). The first 1D wear sensor (7) may comprise a core or body (6). The core or body (6) may be oriented to extend in a direction substantially perpendicular to an outer-facing wear surface profile (22) of the wear liner (4) portion of the wear liner assembly (3), without limitation.

In some embodiments, a wear liner assembly (3) may comprise a (e.g., at least one) second recess (9) in at the second distal end (11). A second 1D wear sensor (7) may be disposed within a least a portion of the (at least one) second recess (9) of the wear liner (4).

The second 1D wear sensor (7) may comprise a core or body (6). The second 1D wear sensor (7) may be oriented to extend in a direction substantially perpendicular to an outer-facing wear surface profile (22) of the wear liner (4) portion of the wear liner assembly (3), without limitation.

In some embodiments, of a wear liner assembly (3), the first and second 1D sensors (7) collectively form a 2D wear sensor (5), without limitation.

In some embodiments, a wear liner assembly (3) may comprise a second recess (9) in at the first distal end (10). A second 1D wear sensor (7) may be disposed within a least a portion of the second recess (9) of the first distal end (10). The first and second 1D wear sensor (7) may collectively form a 2D wear sensor (5), without limitation.

In some embodiments, a wear liner assembly (3) may comprise at least one 1D (7) or 2D (5) sensor disposed in a recess (9) in the second distal end (11), without limitation.

In some embodiments, a wear liner assembly (3) may comprise at least one 1D (7) or 2D (5) sensor disposed in a recess (9) in the first (10) and/or second distal end (11), without limitation.

In some embodiments, a wear liner assembly (3) may comprise at least one third sensor (which may include one or more 1D (7) or 2D (5) sensors) disposed in a recess (9) in a central region of the wear liner (4) between the first (10) and second (11) distal ends, without limitation.

A wear lining system (2) for a grinding apparatus (1), such as a mill, a crusher, or other piece of comminution equipment is also disclosed. The wear lining system (22) may comprise a one or more of the wear liner assembly (3) described above. Multiple different embodiments of a wear liner assembly (3) may be present within the wear lining system (2), without limitation.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures. The illustrations provided are exemplary in nature and not to be construed as limiting the scope of the claimed invention in any way. These figures are merely provided for better understanding of the technical features recited and claimed herein. It would be understood to those skilled in the art that derivations from what is expressly shown are anticipated.

FIG. 1 is an isometric view of a 2D wear sensor for detecting wear according to some embodiments, wherein the sensor is configured to wirelessly transmit wear data from multiple 1D wear sensors therein.

FIG. 2 is an exploded view of the 2D wear sensor shown in FIG. 1.

FIG. 3 is an isometric view of a 2D wear sensor for detecting wear according to some embodiments, wherein the sensor is configured to transmit wear data from multiple 1D wear sensors therein via a cable or wire to a module located in a wear liner. Unlike FIG. 1, FIG. 3 does not show embedded 1D wear sensors 7 for clarity.

FIGS. 4-6 are various isometric views of a wear liner 4 of a wear liner assembly 3, according to some embodiments.

FIG. 7 is a first cutaway view of the wear liner 4 depicted in FIGS. 4-6 to show an optional recess 9 for an optional third 1D wear sensor, without limitation.

FIG. 8 is a second cutaway view of the wear liner 4 depicted in FIGS. 4-6 to show an optional recess 9 for an optional third 2D wear sensor, without limitation.

FIGS. 9 and 10 are various isometric views of a wear liner 4 of a wear liner assembly 3, according to some embodiments.

FIG. 11 depicts one non-limiting embodiment of a printed circuit board 6 having one or more 1D wear sensors 7, which may be incorporated into a (2D) wear sensor 5.

FIG. 12 depicts another non-limiting embodiment of a printed circuit board 6 having one or more 1D wear sensors 7, which may be incorporated into a (2D) wear sensor 5.

FIG. 13 depicts yet another non-limiting embodiment of a printed circuit board 6 having one or more 1D wear sensors 7, which may be incorporated into a (2D) wear sensor 5. This particular embodiment is configured for direct wireless data communication via an antenna 21.

FIG. 14 depicts an optional spacing insert, adapter, or protective cover 14 which may be placed in a wear liner distal end recess 9 over a 2D wear sensor 5 to protect its core or body 6 (e.g., a printed circuit board (PCB)). The spacing insert, adapter, or protective cover 14 may comprise similar mounting features 18 as the mounting features 12 provided to the 2D wear sensor 5, and these may also serve to communicate/mate with the mounting features 8 provided to the wear liner distal end recess 9. The spacing insert, adapter, or protective cover 14 may have thicknesses and/or geometries which are different from that which is depicted. For example, the spacing insert, adapter, or protective cover 14 may be thicker or thinner than what is shown, and may have different peripheral shapes and/or profiles-including cutout regions, openings, or the like, without limitation.

FIG. 15 is a first distal end view of the wear liner 4 depicted in FIGS. 9 and 10, without a wear sensor 5 provided in a first recess 9 of the first distal end 10.

FIG. 16 shows the wear liner 4 depicted in FIG. 15 with a wear sensor 5 disposed in the first recess 9.

FIG. 17 is an inside view of a piece of comminution equipment depicting a wear lining system 2 comprising one or more of the wear liner assemblies 3 shown and described herein. In the particular figure shown, the piece of comminution equipment is a ball mill 1 having a charge 23 therein.

FIGS. 18 and 19 depict two non-limiting embodiments of securing, attaching, bonding, or overmoulding a wear sensor 5 to a wear liner 4. These particular embodiments are most suitable for metallic (e.g., steel) wear liners 4, but similar techniques may be used for polymer-based liners (e.g., hard polyurethane or rubber liners). It should be understood that for polymer-based wear liners 4, wear sensors 5 and/or their optional spacing inserts, adapters, or protective plates 14 may be directly co-moulded with a wear liner 4 during formation of the wear liner 4. Alternatively, in the event polymer-based wear liners 4 are desired, the wear sensors 5 and/or their optional spacing insert, adapter, or protective plates 14 may be subsequently moulded/heat bonded within a recess 9 of a pre-formed polymeric wear liner 4, without limitation.

FIGS. 20 and 21 show different partial isometric views of a wear lining system 2 and one or more modules 30 installed on a shell or substrate to be protected 29 underneath the wear lining system 2. As may be gleaned from FIG. 20, the wear lining system 2 comprises at least one wear liner assembly 3 in accordance with embodiments of the invention. As can be gleaned from FIG. 21, one or more modules 30 may be provided to the shell or substrate to be protected 29 underneath the wear lining system. These modules 30 may be placed entirely within a pocket 25 of a wear liner 4, and/or may be configured to communicate at least partially with a pocket 25 of a wear liner 4 of a wear liner assembly 3. For example, as shown, FLSmidth® LoadIQ® ball charge monitors may be used as the module 30 and may comprise a connector or plug which connects with a reciprocal connector or plug that remains within a pocket 25 of a wear liner 4, without limitation. These module(s) 30 may provide a power source to and/or wireless communication means to/from one or more of the sensors 5, 7 described and depicted herein. For example, one or more wires or cables 17 may operably be coupled and extend between a module 30 and one or more of the sensors 5, 7 described herein. As depicted, a module 30 may be larger than a wear liner pocket 25 and thus, may be externally mounted to the shell or substrate to be protected 29 underneath the wear lining system 2.

FIG. 22 suggests an alternative embodiment wherein one or more 1D wear sensors 7 may be installed at one or both distal ends 10, 11 of a wear liner 4 of a wear liner assembly 3, and/or one or more 2D wear sensors 7 may be installed at one or both distal ends 10, 11 of a wear liner 4 of a wear liner assembly 3.

FIG. 23 suggests an optional 1D wear sensor 7 (e.g., “wear stick”) that may be received into one or more optional recesses 9 located in a central region of a wear liner 4. As with some other embodiments, the 1D wear sensor 7 depicted may comprise a core or body 6 defined as a printed circuit board (PCB) having a resistive parallel circuit thereon. As the 1D wear sensor erodes, a signal produced by the 1D wear sensor may change. This change in signal comprises wear data and may be processed by a computer to determine an amount of damage to the length of the physical structure of the 1D wear sensor 7. Ultimately, the wear data from such a 1D sensor may be used to determine an amount of wear to the wear liner 4 at the location of the optional recess 9 and produce a single real-time wear data point within a digital twin or point cloud representation of the outer-facing wear surface profile 22 of the wear liner 4 and/or of the outer-facing wear surface profile 22 of the wear lining surface 2 it forms a part of.

FIGS. 25-26 show various embodiments of a wear liner assembly 3 when viewed from a distal end 10, 11 thereof.

FIGS. 27 and 28 depict how a module 30 may be operatively connected to one or more 1D 7 and/or 2D sensors 5 of a wear liner assembly 3, for example, via one or more cables or wires 17. The module 30 may provide a power source, such as a battery 20, and/or means for communicating data, such as an antenna 21, without limitation. A connector may be used to easily separate the module 30 from the wear liner assembly 3. A filler material or plug comprising a sealing polymeric material may fill remaining portions of pocket 25 and/or hole 32, without limitation.

### DETAILED DESCRIPTION OF THE DRAWINGS

In some detailed embodiments, a physical wear sensor(s) 5 may be provided to a wear liner 4. The particular orientation and/or location of the wear sensor(s) 5 may be configured such that the wear sensor(s) 5 can determine where an outer surface profile 22 dimension of the wear liner 4 is reduced over time, as the wear liner 4 is worn. This may be done by placing the wear sensor(s) 5 in a protected area between wear liners 4 (e.g., in a longitudinal direction, and/or where wear liner side and/or end surfaces meet, without limitation). By providing a “2D” wear sensor 5 comprised of several strategically-arranged and oriented “1D” wear sensors 7 to one or more portions of a wear liner 4—and/or to one or more portions of multiple wear liners 4 within a wear lining system 2 (e.g., a mill lining system), the outer-facing wear surface profile 22 of the wear liner 4 may be measured at one or more liner abutment interfaces.

By reducing the spacing between and/or increasing the number of the 1D wear sensors 7 arranged within a 2D wear sensor 5 (e.g., on a printed circuit board 6 thereof), wear data resolution and number of wear measurement points of the outer-facing wear surface profile 22 may be increased. Wear sensors 5 may be integrated with wear liners 4 in a minimally-invasive manner by configuring the wear sensors 5 with substantially flat or substantially planar forms.

In some embodiments, a wear liner 4 incorporating one or more of these novel 2D wear sensors 5 may be reduced in size (e.g., shorter in overall length) when compared to a wear liner it intends to replace. In this regard, more 2D wear sensors may be incorporated within a wear lining system 2 thus providing a greater number of wear measurement points and higher data resolution as it pertains to an outer-facing wear surface profile 22. Moreover, an increased number of (and/or closer spacing of) 1D 7 and/or 2D wear sensors 5 can increase wear data resolution, thus providing more information regarding the condition of a wear lining system 2. A wear lining system 2 (e.g., a grinding mill 1 lining system) in accordance with embodiments of the invention may, in some instances, comprise larger wear liners each having a number of smaller wear liner “segments”, wherein each wear liner “segment” within a larger wear liner may comprise its own wear liner 4 and one or more of its own wear sensors 5, without limitation.

One or more recesses 9 (e.g., such as pockets, counterbores, blind holes, through-holes, recessed shelves, or the like), may be formed in one or more sides or longitudinal ends of a wear liner to provide space or clearance for accepting a wear sensor. In some embodiments, the space or clearance created by each recess may be configured to be large enough for accepting its respective wear sensor(s) and one or more additional components. The one or more additional components may comprise, for instance, a spacing insert, adapter, and/or a protective cover 14 (e.g., metallic plate), adhesive 15, and/or filling material or “filler” 16 (e.g., epoxy, polyurethane, rubber, potting adhesive, cement, bonding agent) adjacent surfaces of the wear sensor, without limitation. These additional components may be combined in any permutation or number, and it should be understood by those ordinarily-skilled in the art that there may be a plurality of a particular one of the aforementioned additional components in certain embodiments.

In some embodiments, as shown, the one or more recesses 9 may comprise a recess which protrudes longitudinally into one or both distal ends 10, 11 of the wear liner 4.

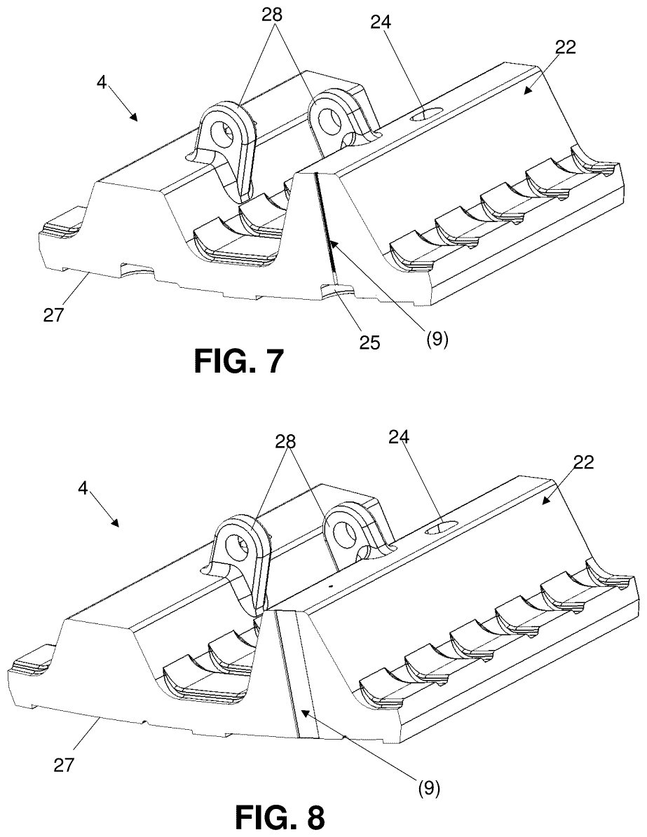

Moreover, some embodiments, as shown, the one or more recesses 9 may comprise a recess 9 which protrudes into the wear liner in a direction which is substantially transverse to, substantially orthogonal to, or substantially perpendicular to an outer-facing wear surface profile 22 portion of the wear liner 4. While not necessarily preferred due to the adverse risks outlined in the background section of this specification, these optional recesses 9 provided more centrally to the wear liner 4 may extend partially or entirely through the wear liner (e.g., as suggested in the non-limiting embodiment shown in FIGS. 7 and/or 8). In preferred embodiments, one or both distal ends of the wear liner may each comprise its own recess 9 (e.g., pocket, counterbore, blind-hole, recessed shelves) of preferred shape which is configured to receive and retain a substantially complimentary-shaped 2D wear sensor 5, without limitation. While four different recesses 9 are depicted in the figures, it should be understood that any one or more of the recesses 9 depicted may be optionally omitted-so long as at least one recess 9 remains in the wear liner 4 for receiving at least one wear sensor 5.

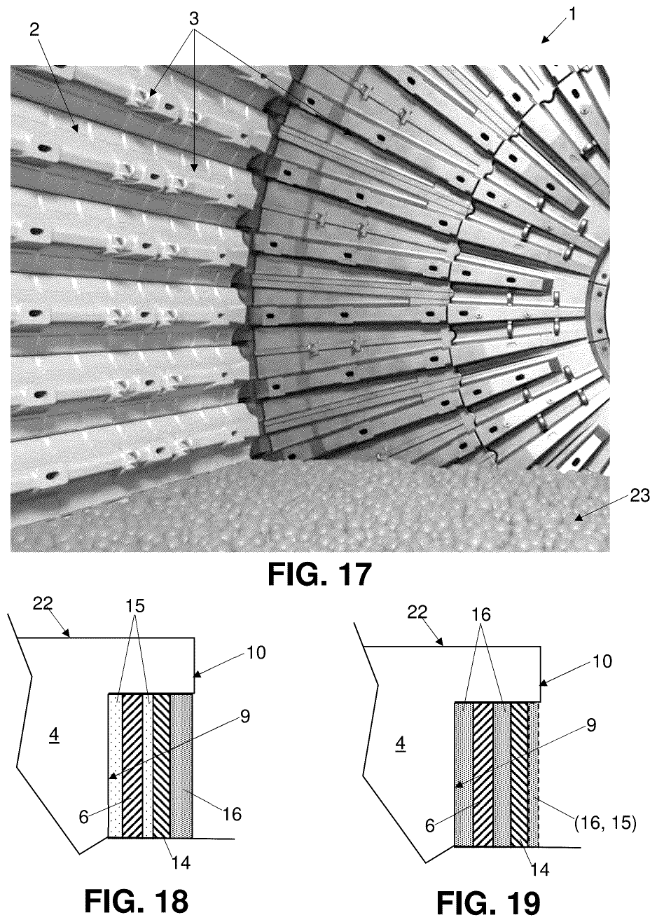

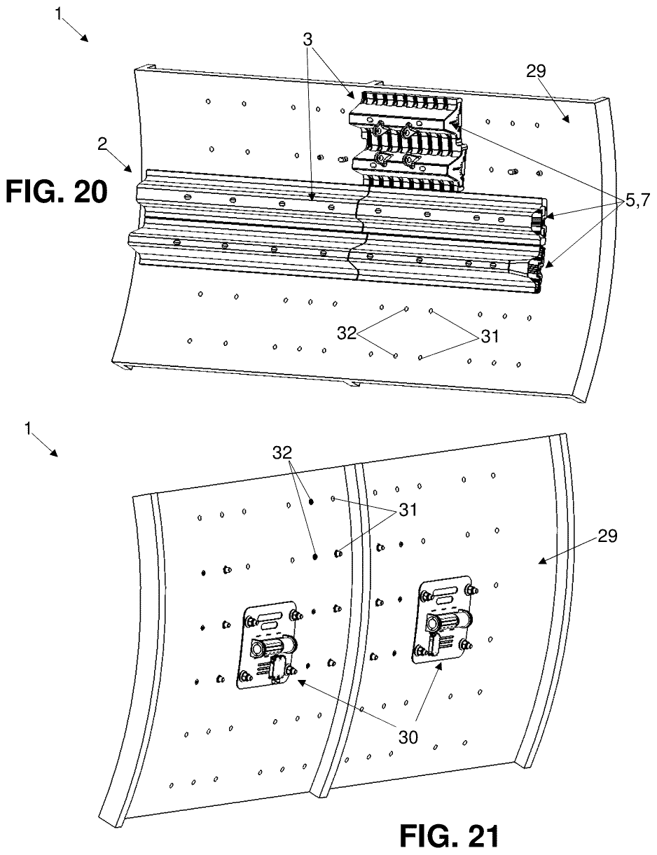

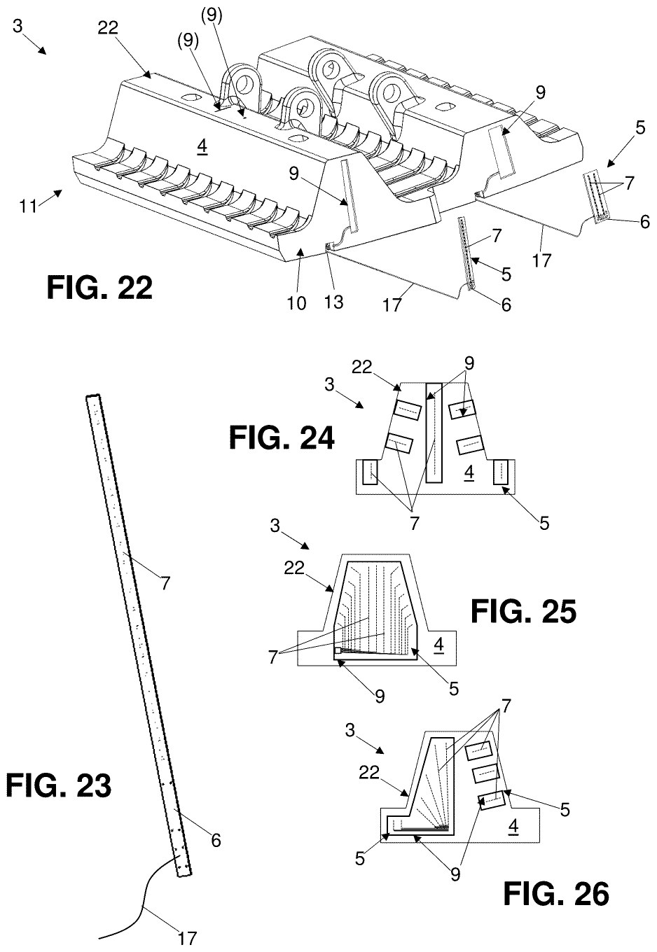

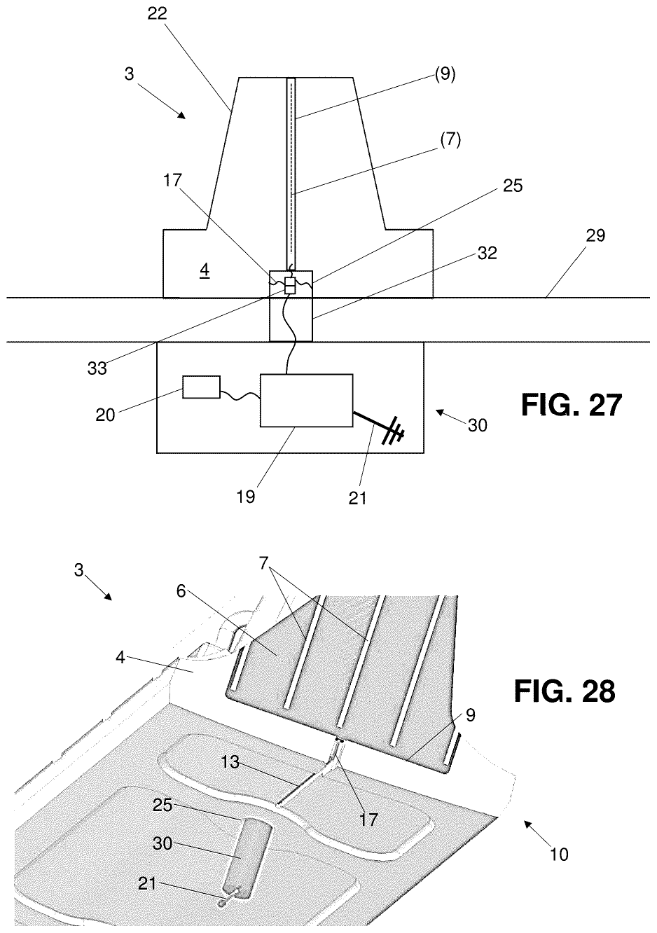

Turning now to the figures, a grinding apparatus 1 (e.g., a mill, crusher, piece of comminution equipment, or the like) may be provided with a wear lining system 2. The wear lining system 2 may comprise one or more wear liner assemblies 3. As suggested in FIG. 17, the grinding apparatus 1 may comprise a horizontal mill having a charge 23 therein. The charge 23 may comprise rods, balls, or abrasive material, without limitation.

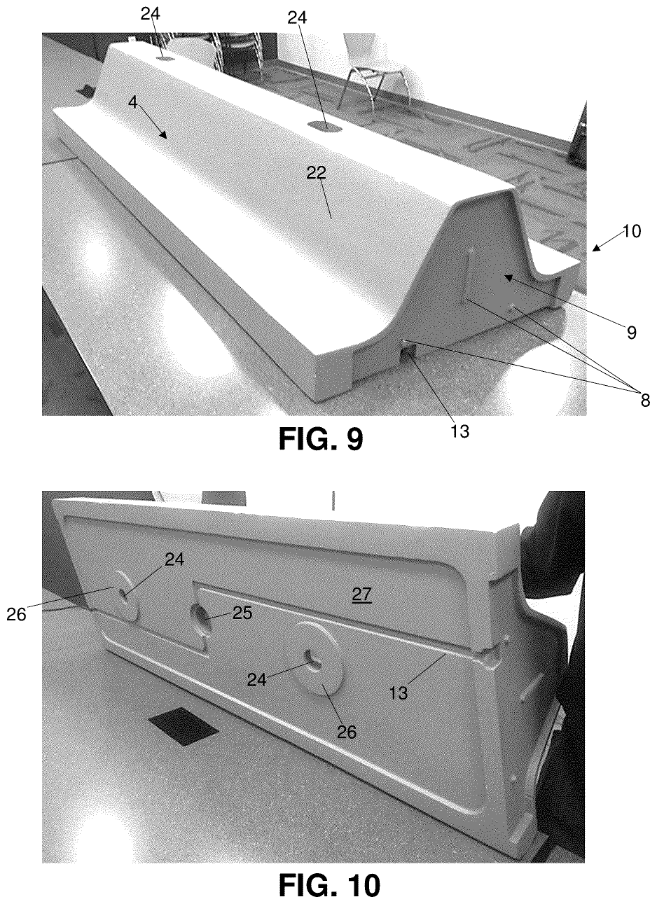

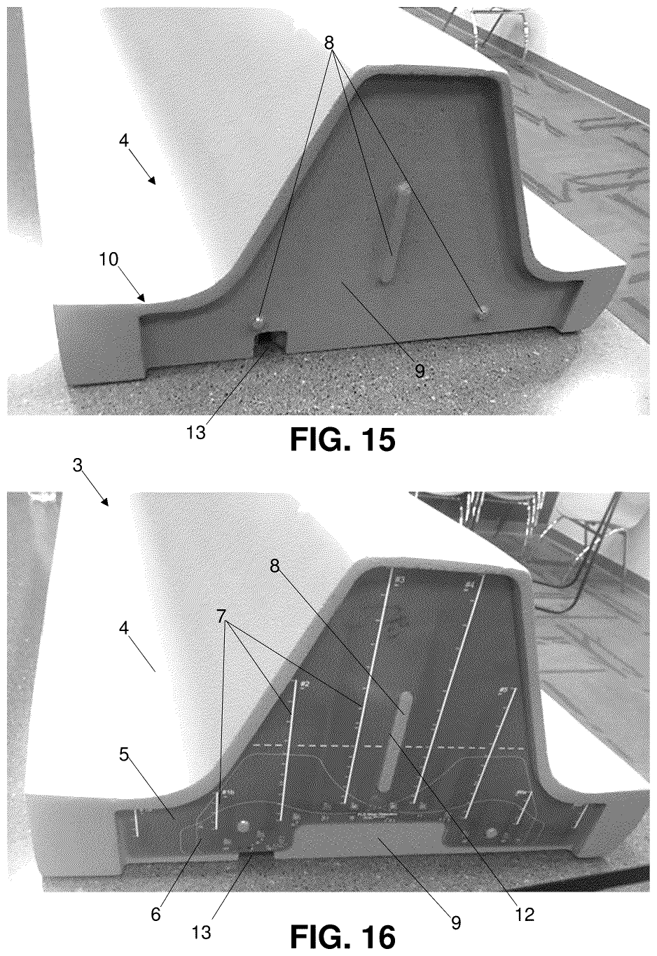

The charge 23 may be monitored and/or controlled by a system such as FLSmidth® LoadIQ™. It should be understood that the wear liner assemblies 3 may be provided with wear liners 4 having different geometries and/or which may be “doubled up” side-by-side (as shown in FIGS. 4-8), or provided as “single” wear liner units (as shown in FIGS. 9, 10, 15, 16), without limitation.

Each wear liner assembly 3 may comprise a wear liner 4. The wear liner 4 may be equipped with a first distal end 10 and a second distal end 11. The first 10 and second 11 distal ends may be opposite of each other along an axis extending between the first 10 and second 11 distal ends as depicted. A lower undersurface of the wear liner 4 may be provided with one or more mounting holes 24, e.g., for receiving one or more fasteners or bolts for attaching the wear liner assembly 3 to a portion of the grinding apparatus 1 and/or to form a portion of the wear lining system 2 thereof.

At one or both distal ends 10, 11 of the wear liner 4 may be provided a recess 9 for accepting a thin wear sensor 5 (e.g., 2D wear sensor). As suggested by FIGS. 18 & 19, the recess 9 may also be configured to accept spacing insert, adapter, or protective plate 14 (e.g., metallic or steel cover), one or more layers of adhesive 15 (e.g., epoxy), and/or one or more layers of filling material or “filler” 16 (e.g., epoxy, polyurethane, rubber (e.g., unvulcanized), potting adhesive, cement, or bonding agent), in any combination or order of application, without limitation.

Each ware sensor 5 may comprise a core or body 6, such as a printed circuit board (PCB). It is envisaged that the core or body 6 may comprise a panel of any suitable material that can provide a base for mounting electronic circuitry. It is further anticipated that instead of PCB, which is a non-conductive base material to mount electronic components on, a panel, board, mount, or substrate that is capable of supporting, receiving, mounting, adhering, or otherwise attaching any discrete wear sensor element thereon may be utilized as the core or body 6. For example, one or more wear sensors or wear sensing elements (e.g., each having or being positioned in either an a 1D or 2D geometrical configuration) may adequately solve the same technical problem and provide an equivalent to the preferred PCB-mounted sensor embodiment depicted.

On the core or body 6 may be provided a number of 1D wear sensors 7-preferably a plurality of 1D wear sensors 7. The 1D wear sensors are preferably spaced from each other and may preferably extend substantially parallel to one another, or at least substantially in a similar direction. However, it is envisaged that some 1D wear sensors 7 may extend in different directions on the core or body 6. It is further envisaged that in some embodiments, one or more of the 1D wear sensors 7 may extend substantially orthogonally to a local surface portion or region of an outer-facing wear surface profile 22.

A 1D wear sensor may comprise a wear (indication) strip, for example, comprised of one or more parallel resistive circuits. As the 1D sensor erodes away, a signal associated with it may change. This signal may include information relating to changes in current, voltage, or resistive impedance, without limitation.

A recess 9 provided to a distal end 10, 11 of a wear liner 4 may comprise one or more mounting features 8. A plurality of mounting features 8 may be employed as shown. If a plurality of mounting features 8 are employed within a recess 9, they may take different forms (e.g., at least one elongated mounting feature and/or at least one non-elongated or symmetrical mounting feature as depicted). As depicted, these mounting features 8 may be provided in a predetermined staggered manner as shown- or otherwise angled or arranged to ensure a single correct installation orientation for a wear sensor 5 to be disposed therein.

A (2D) wear sensor 5 may comprise one or more complimentary mounting features 12 which are configured to communicate/mate with the one or more mounting features 8 in a recess 9. If employed, a spacing insert, adapter, or protective cover 14 may share similar complimentary mounting feature 18 which are also configured to communicate/mate with the one or more mounting features 8 in a recess 9. In some embodiments a portion of the profile of the recess (and/or an edge or surface thereof) may serve as one as more mounting features 8, without limitation. In some embodiments, a portion of the profile (and/or an edge or surface thereof) may serve as one or more mounting features 18, without limitation.

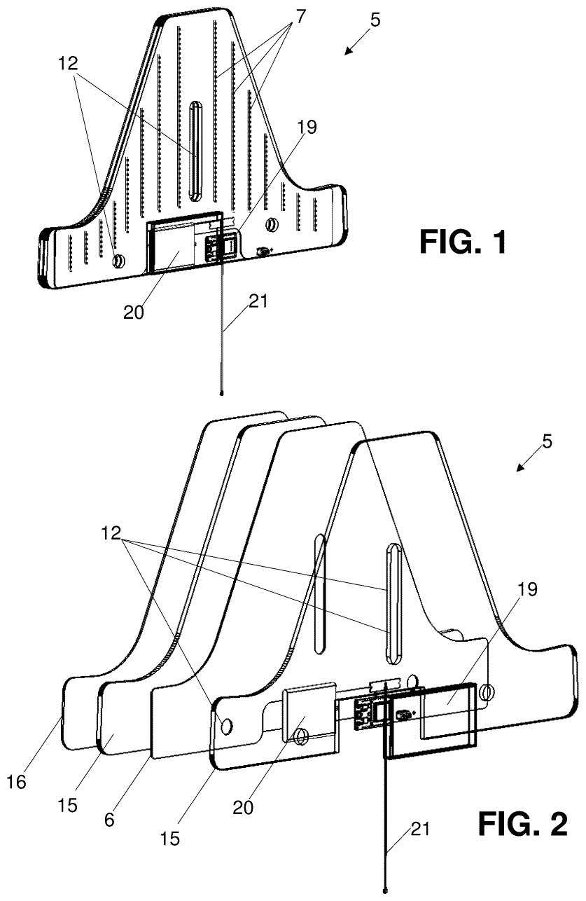

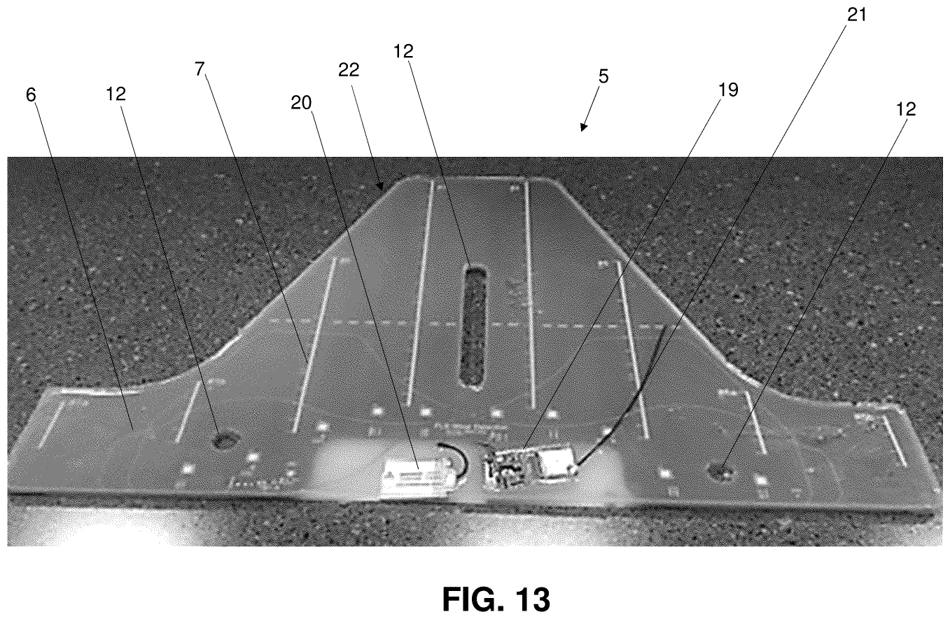

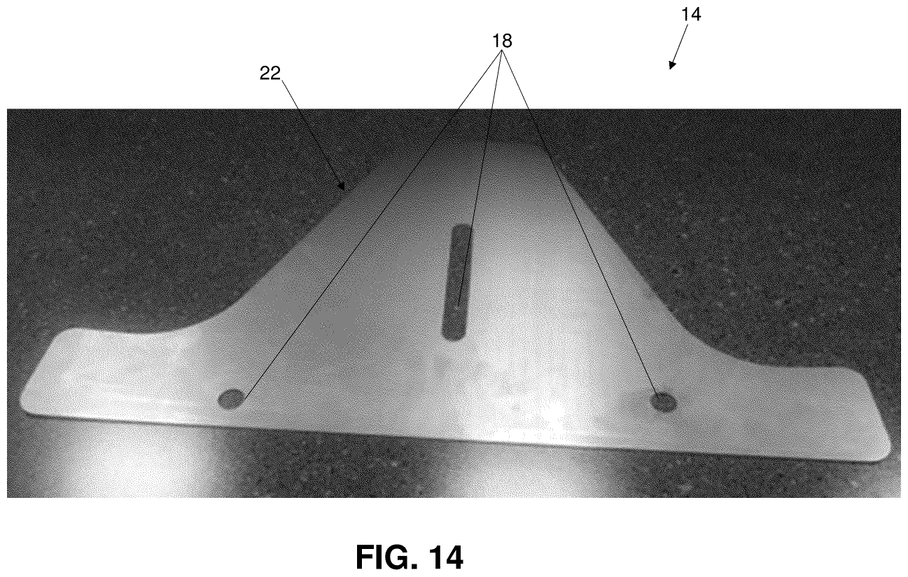

A (2D) wear sensor 5 may, as depicted in FIGS. 1, 2, and 13, may comprise an onboard microcontroller 19, battery 20, and/or antenna (e.g., an RF antenna). One or more of these may be integrally-provided to the core or body 6 with the 1D wear sensor(s) 7.

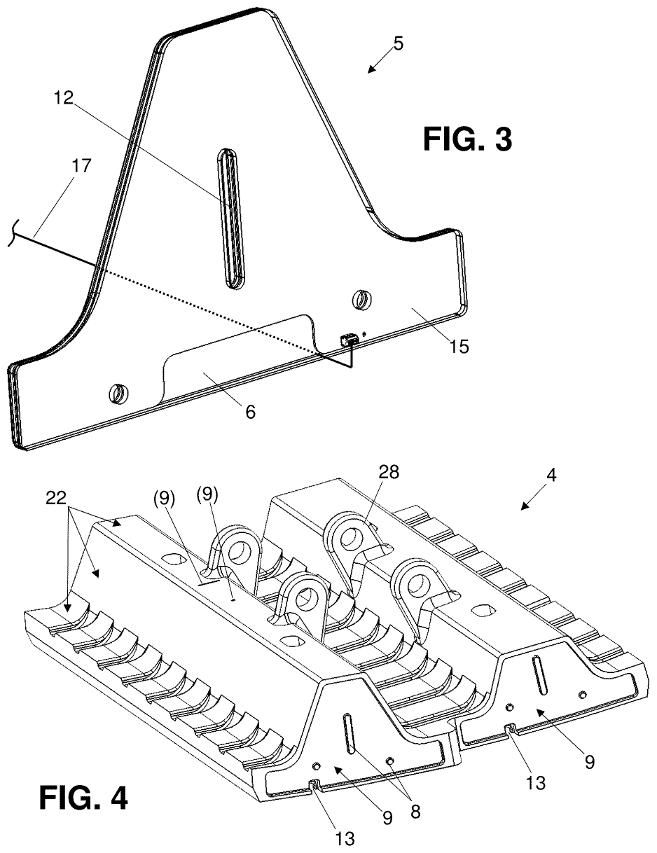

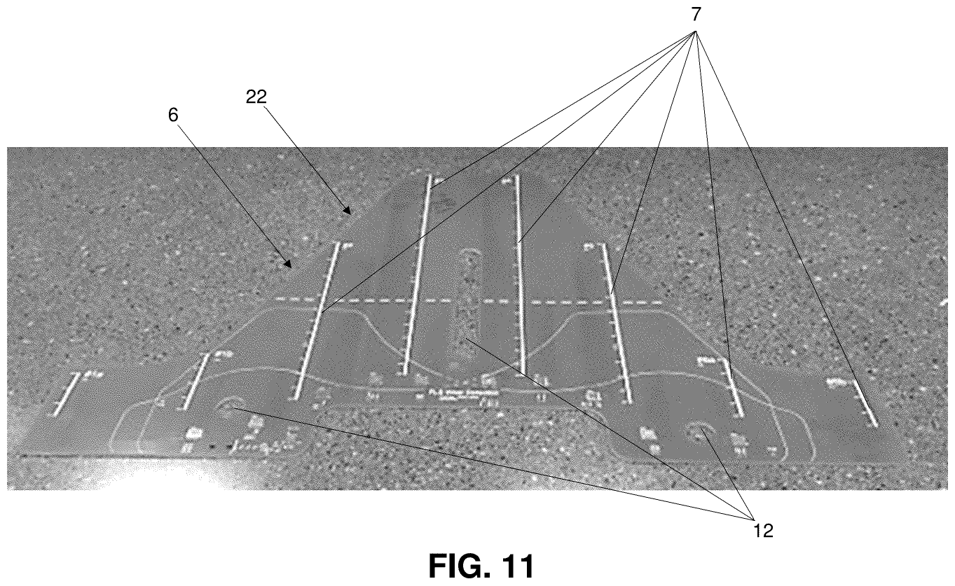

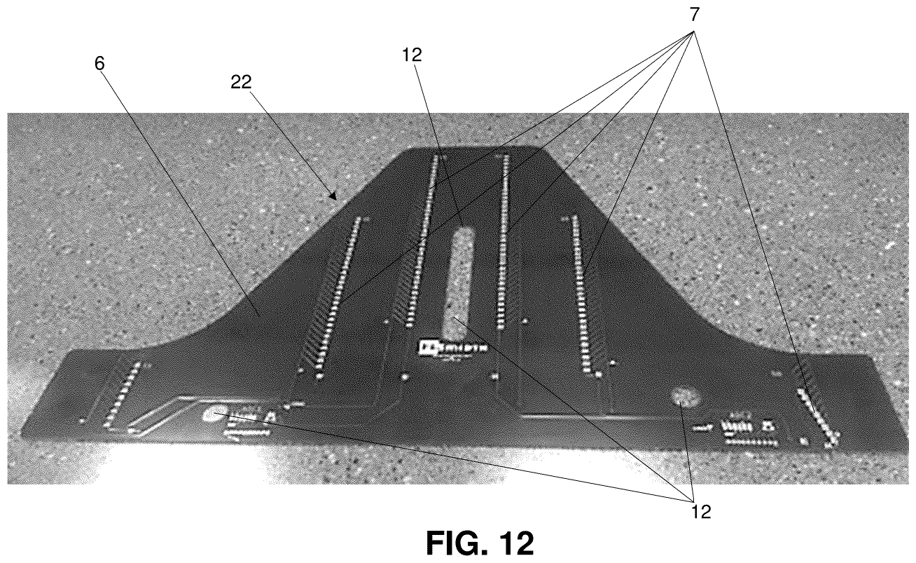

A (2D) wear sensor 5 may, as depicted in FIGS. 3, 11, and 12, may comprise a wire or cable 17 extending from the core or body 6. The wire or cable 17 may be configured and used to deliver digital or analog signals comprising wear information (e.g., wear status of one or more 1D wear sensors) to a communication module (not shown). The communication module may be provided within a pocket 25 extending into a lower undersurface of the wear liner 4. Similar to each sensor 5, the communication module may comprise its own core or body 6 (e.g., a PCB) also having an onboard microcontroller 19, battery 20, and/or antenna (e.g., an RF antenna), without limitation.

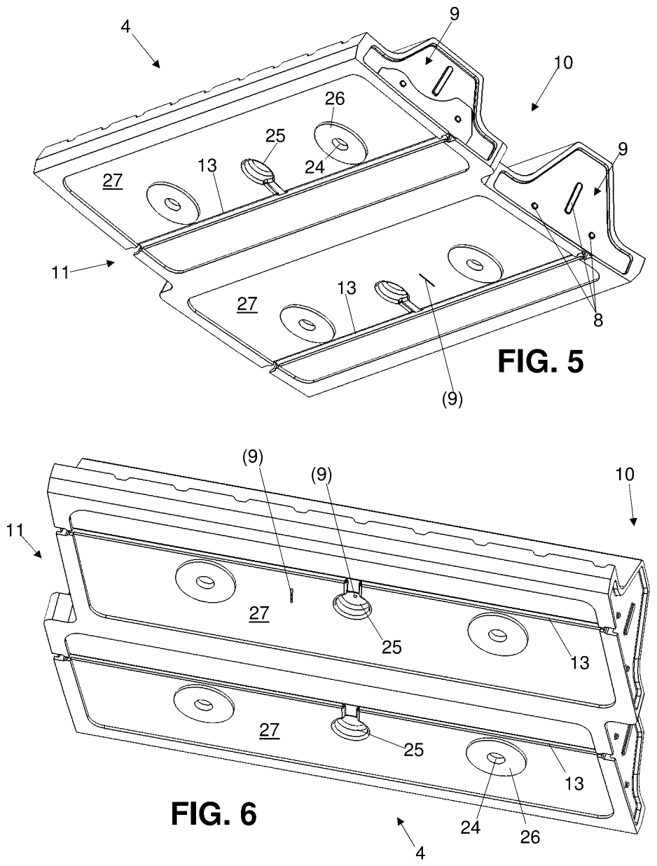

One or more passages 13 may extend between the pocket 25 and one or more recesses 9 (most clearly seen in FIGS. 5 and 6). The one or more passages 13 may be configured to receive/house a wire or cable 17 extending from a wear sensor 5.

In some embodiments, a lower undersurface of a wear liner 4 may comprise a mounting boss 26 around one or more of the mounting holes 24 provided to the wear liner 4. An underside recess 27 may be formed in the lower undersurface and extend between one or more mounting bosses 26 and a lower perimeter or edge of the wear liner 4. In some embodiments, one or more lift eyes 28 may be provided to a wear liner 4 of a wear liner assembly 3.

In this specification, adjectives such as first and second, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art in view of the above teachings. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above-described invention.

For example, while the wear liner assemblies 3 discussed herein are shown to be used in reference to a grinding mill, the same may be equally employed to feeder chutes, hoppers, bins, and other surfaces which are prone to wear due to exposure to moving abrasive materials.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

### LIST OF REFERENCE IDENTIFIERS

1 Grinding apparatus (e.g., mill, crusher, comminution equipment)
2 Wear lining system
3 Wear liner assembly
4 Wear liner
5 Wear sensor (e.g., 2D wear sensor)
6 Core or body (e.g., Printed Circuit Board (PCB), panel, plate, mountable substrate)
7 1D wear sensor (e.g., wear strip)
8 Mounting feature (wear liner)
9 Recess
10 First distal end
11 Second distal end
12 Mounting feature (wear sensor)
13 Passage (for wire or cable)-optional
14 Spacing insert, adapter, or protective plate (e.g., metallic, steel)
15 Adhesive (e.g., epoxy)
16 Filling material or “filler” (e.g., epoxy, polyurethane, rubber (e.g., unvulcanized), potting adhesive, cement, bonding agent)
17 Wire or cable
18 Mounting feature (protective plate)
19 Onboard microcontroller
20 Battery
21 Antenna (e.g., RF)
22 Out-facing wear surface profile
23 Charge
24 Mounting hole (for fastener or bolt)
25 Pocket (e.g., which may align with a knock-out hole or bolt hole in a mill shell)
26 Mounting boss
27 Underside recess
28 Lift eye
29 Shell or substrate (of grinding apparatus 1) to be protected under wear lining system 2
30 Module (e.g., charge monitoring system with onboard power supply and wireless transmitter)
31 Bolt holes
32 Bolt holes or optional knock-out holes
33 Connector (e.g., plug)

What is claimed is:

1. A wear liner assembly (3) for a wear lining system (2) provided within industrial comminution equipment comprising:
a wear liner (4) having:
a first distal end (10);
a second distal end (11) opposite the first distal end;
a first recess (9) in at least the first distal end (10); and,
a first 2D wear sensor (5) disposed within a least a portion of the first recess (9) of the wear liner (4), the first 2D wear sensor (5) comprising:
a core or body (6) containing a plurality of 1D wear sensors (7), each of the 1D wear sensors (7) being spaced from one another and oriented to extend in substantially the same plane.

2. The wear liner assembly (3) according to claim 1, further comprising a first spacing insert, adapter, or protective component (14) within the first recess (9).

3. The wear liner assembly (3) according to claim 2, wherein the first spacing insert, adapter, or protective component (14) is configured to shield, case, or protect the core or body (6) of the first 2D wear sensor (5).

4. The wear liner assembly (3) according to any one of the preceding claims, further comprising at least one mounting element (8) provided to the recess (9), and a corresponding mounting element (12) provided to the first 2D wear sensor (5) which is configured to communicate with the mounting element (8) provided to the recess (9).

5. The wear liner assembly (3) according to claim 4, wherein upon communication between the mounting element (8) provided to the recess (9) and the mounting element (12) provided to the first 2D wear sensor (5), the 2D wear sensor (5) is properly oriented within the first recess with respect to the wear liner.

6. The wear liner assembly (3) according to any one of the preceding claims, further comprising a second recess (9) in the second distal end (11), and a second 2D wear sensor (5) disposed within a least a portion of the second recess (12) of the wear liner (4), the second 2D wear sensor (5) comprising:
a core or body (6) containing a plurality of 1D wear sensors (7), each of the 1D wear sensors (7) being spaced from one another and oriented to extend in substantially the same direction and/or within substantially the same plane.

7. The wear liner assembly (3) according to any one of the preceding claims, further comprising at least one third sensor extending through a central portion of the wear liner, the at least one third sensor comprising:
a 2D wear sensor comprising a plurality of 1D wear sensors (7), or,
a 1D wear sensor
the at least one third sensor being positioned within at least one third recess (9) extending substantially transversely and/or orthogonally to an axis extending from the first distal end (10) to the second distal end (11).

8. The wear liner assembly (3) according to claim 7, wherein the at least one third sensor is provided within a recess (9) that intersects with a pocket (25) provided in a lower undersurface of the wear liner (4) which is opposite an outer-facing wear surface profile (22) of the wear liner (4).

9. The wear liner assembly (3) according to claim 7, wherein the wear liner (4) comprises a passage (13) extending from a pocket (25) provided in a lower undersurface of the wear liner (4), to the first recess (9).

10. The wear liner assembly (3) according to claim 8, wherein the wear liner (4) comprises a passage (13) extending from the pocket (25) to a second recess (9) provided to the second distal end (11).

11. The wear liner assembly (3) according to any one of the preceding claims, wherein each of the 1D wear sensors of the first 2D wear sensor extend in a direction towards an outer-facing wear surface profile (22) of the wear liner (4) or first 2D wear sensor (5).

12. The wear liner assembly (3) according to any one of the preceding claims, wherein each of the 1D wear sensors (7) of the first 2D wear sensor (5) extend substantially same direction.

13. The wear liner assembly (3) according to any one of the preceding claims, wherein each of the 1D wear sensors (7) of the first 2D wear sensor (5) extend substantially radially towards a central axis of a horizontal grinding mill (1).

14. The wear liner assembly (3) according to any one of the preceding claims, wherein the first 2D wear sensor (5) is configured to broadcast a signal wirelessly via an onboard antenna (21).

15. The wear liner assembly (3) according to any one of the preceding claims, wherein the first 2D wear sensor (5) is configured with a wire or cable to deliver a signal to a remotely positioned module in a pocket (25) on the wear liner assembly (3).

16. The wear liner assembly (3) according to any one of claims 2-15, wherein the spacing insert, adapter, or protective plate (14) comprises mounting features (18) that align with the mounting features (12) of the first 2D wear sensor (5).

17. The wear liner assembly (3) according to any one of the preceding claims, wherein the core or body (6) comprises a printed circuit board (6).

18. The wear liner assembly (3) according to any one of the preceding claims, wherein at least two of the 1D wear sensors (7) of the first 2D wear sensor (5) extend in different directions and/or at an angle with respect to one another, such that a first longitudinal wear measuring axis defined along a first one of the at least two of the 1D wear sensors (7) is not parallel to a second longitudinal wear measuring axis defined along a second one of the at least two of the 1D wear sensors (7).

19. The wear liner assembly (3) according to any one of the preceding claims, wherein at least one of the 1D wear sensors (7) of the first 2D wear sensor (5) extend substantially orthogonally and/or perpendicular to an outer-facing wear surface profile (22) of the wear liner (4).

20. The wear liner assembly (3) according to any one of the preceding claims, wherein a plurality of said 1D sensors (7) are positioned at a non-perpendicular angle relative to an outer-facing wear surface profile (22) of the wear liner (4).

21. A method of optimizing operating efficiency of a grinding apparatus (1), such as a mill, a crusher, or other piece of comminution equipment having a wear lining system (2) therein, the method comprising:
providing the wear liner assembly (3) according to any one of claims 1-20 or 24 to the wear lining system (2), such that an outer-facing wear surface profile (22) of the wear liner (4) portion of the wear liner assembly (3) forms a portion of an outer-facing wear surface profile (22) of the wear lining system (2);
monitoring a condition of the first 2D wear sensor (5) by virtue of receiving one or more signals from the first 2D wear sensor (5); the one or more signals from the first 2D wear sensor (5) comprising wear data associated with a wear condition or physical state of each one of the 1D wear sensors (7);
processing the wear data using a computer equipped with a processor and a non-transitory computer-readable medium;
creating a two-dimensional electronic digital twin or point cloud representation of the wear data, using the wear data from the one or more signals from the first 2D wear sensor (5);
determining an operating efficiency of the grinding apparatus 1, based on said electronic digital twin or point cloud representation of the wear data.

22. The method according to claim 21, further comprising:
providing a plurality of the wear liner assembly (3) to the wear lining system (2);
monitoring a condition of each first 2D wear sensor (5) of each wear liner assembly (3) by virtue of receiving one or more signals from each first 2D wear sensor (5);
the one or more signals from each first 2D wear sensor (5) comprising wear data associated with a wear condition or physical state of the 1D wear sensors (7) associated with each first 2D wear sensor (5);
processing wear data from each of the first 2D wear sensor (5) using the computer equipped with a processor and a non-transitory computer-readable medium;
creating a three-dimensional electronic digital twin or point cloud representation of the wear data, using the wear data from the one or more signals from each first 2D wear sensor (5);
determining an operating efficiency of the grinding apparatus 1, based on said electronic digital twin or point cloud representation of the wear data.

23. The method according to claim 21 or 22, further comprising:
determining if said operating efficiency is below a predetermined threshold or value; and
replacing or scheduling the replacement the entire wear lining system (2) or a portion thereof, such as replacing one or more of the wear liner assembly (3) if the operating efficiency is below the predetermined threshold or value.

24. A wear liner assembly (3) for a wear lining system (2) provided within industrial comminution equipment comprising:
a wear liner (4) having:
a first distal end (10);
a second distal end (11) opposite the first distal end; and
at least one third sensor disposed in a recess (9) in a central region of the wear liner (4) between the first (10) and second (11) distal ends;
the at least one third sensor comprising: a 2D wear sensor (5) comprising a plurality of 1D wear sensors (7);
the 2D wear sensor (5) comprising: a core or body (6) containing the plurality of 1D wear sensors (7), each of the 1D wear sensors (7) being spaced from one another and oriented to extend in substantially the same plane.
